(19) United States
(12) Patent Application Publication
(10) Pub. No.: US 2024/0286265 A1
(43) Pub. Date: Aug. 29, 2024

(54) TOOL FOR ADDITIONAL MECHANICAL ADVANTAGE

(71) Applicant: Patrick McGinnis, Emlenton, PA (US)

(72) Inventor: Patrick McGinnis, Emlenton, PA (US)

(21) Appl. No.: 18/113,338

(22) Filed: Feb. 23, 2023

(51) Int. Cl. B25G 1/00; B25B 13/48

(52) U.S. Cl. CPC B25G 1/005; B25B 13/481

(57) ABSTRACT

A tool for mechanical advantage which allows for a wrench to be attached to other tools such as ratchets, breaker bars, and any other tool with a square head. Furthermore, in some embodiments the tool for mechanical advantage has a hinge that allows the user to approach fasteners for different angles of attack.

### FIELD OF THE INVENTION

The present subject matter relates to gaining additional mechanical advantage on a wrench.

### BACKGROUND OF THE INVENTION

A common tactic for mechanics or other craftsmen to achieve additional leverage with a wrench is to attach another wrench to the distal end of the wrench attached to a bolt or nut. This can result in a dangerous situation where the two wrenches fly apart and cause damage either to the user or the machinery around it.

### OBJECTS OF INVENTION

A primary object of the present subject matter is to eliminate this problem by cradling the shank of any box wrench. This allows the user to gain additional leverage without the risk of multiple wrenches flying apart and causing damage.

### BRIEF SUMMARY OF THE INVENTION

The present subject matter has a small magnet imbedded in the body of the present subject matter which helps maintain contact with the wrench. The present subject matter has two arms that hold the wrench in the direction of rotation. The arms 25 are able to latch into place and work in tandem with the neodymium magnet 15 preventing to keep the wrench in place.

The present subject matter then allows for a wrench to be connected to a ratchet, breaker bar, or any other tool with a square head via 0.5-inch square cutout 35 that may require additional leverage to operate. There is also a secondary ⅜-inch square head cutout 40 that is meant to accommodate any kind of ratchet, breaker bar, or any other type of tool that uses a square head.

To change the direction of rotation the present subject matter is placed on the appropriate side of the wrench. The device also extends the reach of a torque wrench into tight or inaccessible places to allow proper torquing of fasteners. Furthermore, the present subject matter also enables the ability to adjust the angle of engagement of fasteners.

### BRIEF DESCRIPTION OF THE DRAWINGS

FIG. 1 is a front view of the present subject matter with the arms unbent.

FIG. 2A is a front view of the present subject matter with the wrench located inside the tool for mechanical advantage.

FIG. 2B is a right side view of the present subject matter with the wrench located inside the tool for mechanical advantage.

FIG. 2C is a left side view of the present subject matter with the wrench located inside the tool for mechanical advantage.

FIG. 2D is a back view of the present subject matter with the wrench located inside the tool for mechanical advantage.

FIG. 2E is a front view of one embodiment of the present subject matter which depicts a neodymium magnet 15, body 20, and hinge 30.

FIG. 2F is a side view of one embodiment of the present subject matter which depicts a neodymium magnet 15, body 20, and hinge 30 of the tool for mechanical advantage.

FIG. 3A is a right side view of the present subject matter which depicts a wrench being attached to a ratchet using the tool for mechanical advantage.

FIG. 3B is a left side view of the present subject matter which depicts a wrench being attached to a ratchet using the tool for mechanical advantage.

FIG. 4 is a front view of a ratchet attached to the present subject matter without a wrench locked into the present subject matter and represents how a ratchet, breaker bar, or any other tool with a square head can be coupled to the tool for mechanical advantage.

FIG. 5 is a front view of a ratchet attached to the present subject matter with a wrench locked into the present subject matter and represents how a ratchet, breaker bar, or any other tool with a square head can be coupled to the tool for mechanical advantage.

FIG. 6 is a left side view of a ratchet attached to the present subject matter with a wrench locked into the present subject matter and represents how a ratchet, breaker bar, or any other tool with a square head can be coupled to the tool for mechanical advantage.

FIG. 7A is a front view of the present subject matter.

FIG. 7B is a right side view of the present subject matter.

FIG. 7C is a back side view of the present subject matter.

FIG. 7D is an end view of the present subject matter.

Some embodiments of the present invention are illustrated as an example and are not limited by the figures of the accompanying drawings, in which like references may indicate similar elements.

### DETAILED DESCRIPTION OF THE INVENTION

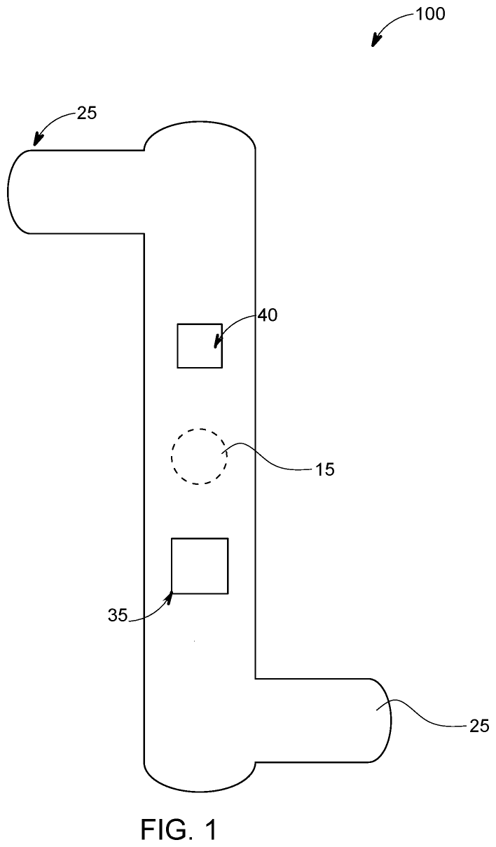

FIG. 1 is a front view of the present subject matter with the arms 25 unbent. The present subject matter has a neodymium magnet 15 which works in combination with arms 25 to secure a wrench to the tool for mechanical advantage. The present subject matter also has two cutouts 35, 40 which are designed to accommodate any type of tool with ⅜ inch or 0.5-inch square head.

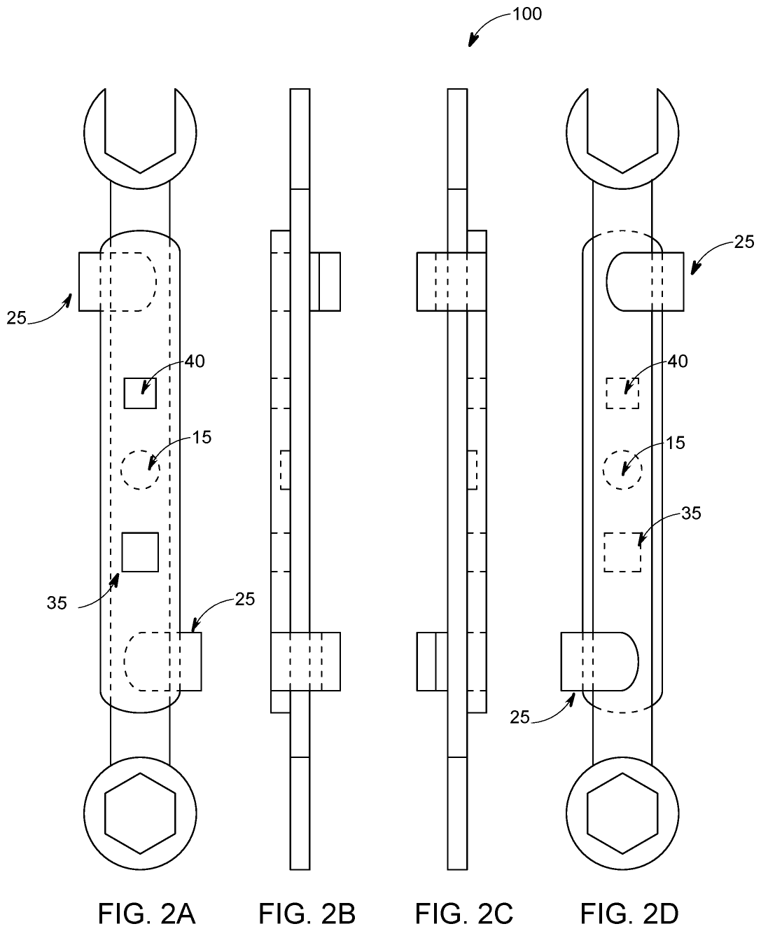

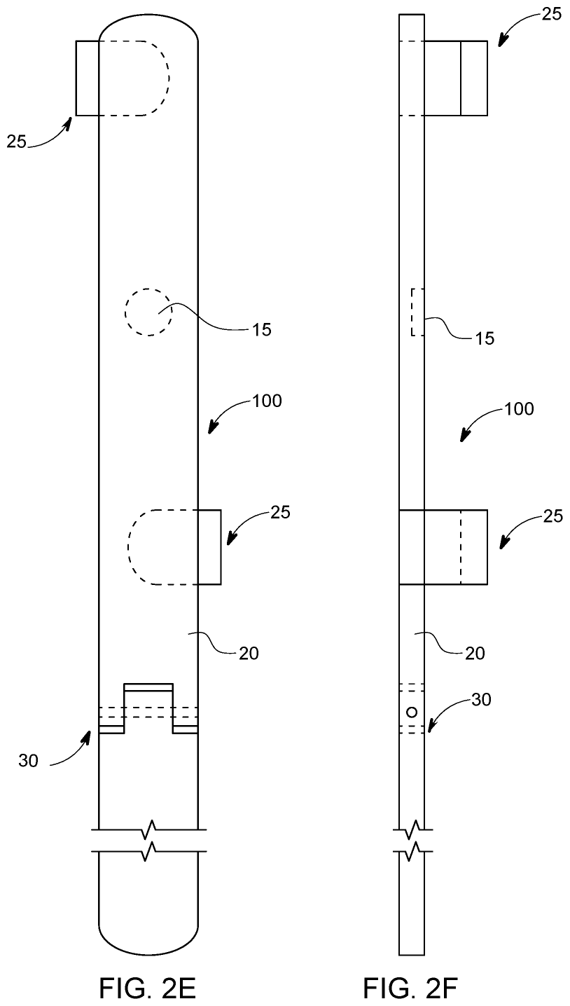

FIG. 2A is a front view of the present subject matter with the wrench located inside the tool for mechanical advantage. Arms 25 in combination with neodymium magnet 15 latch the wrench in place. In this illustration neither of the cutouts are in use.

FIG. 2B is a right side view of the present subject matter with the wrench located inside the tool for mechanical advantage.

FIG. 2C is a left side view of the present subject matter with the wrench located inside the tool for mechanical advantage.

FIG. 2D is a back view of the present subject matter with the wrench located inside the tool for mechanical advantage. Arms 25 in combination with neodymium magnet 15 latch the wrench in place. In this illustration neither of the cutouts are in use.

FIG. 2E is a front view of one embodiment of the present subject matter which depicts a neodymium magnet 15, body 20, and hinge 30. Hinge 30 allows for the user to approach a fastener from different angles of approach.

FIG. 2F is a side view of one embodiment of the present subject matter which depicts a neodymium magnet 15, body 20, and hinge 30 of the tool for mechanical advantage. Hinge 30 allows for the user to approach a fastener from different angles of approach.

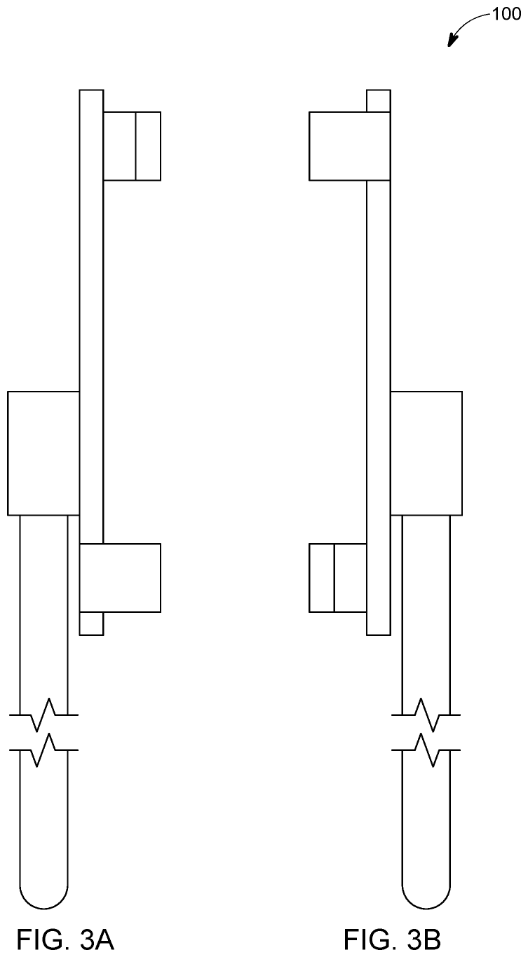

FIG. 3A is a right side view of the present subject matter which depicts a wrench being attached to a ratchet using the tool for mechanical advantage.

FIG. 3B is a left side view of the present subject matter which depicts a wrench being attached to a ratchet using the tool for mechanical advantage.

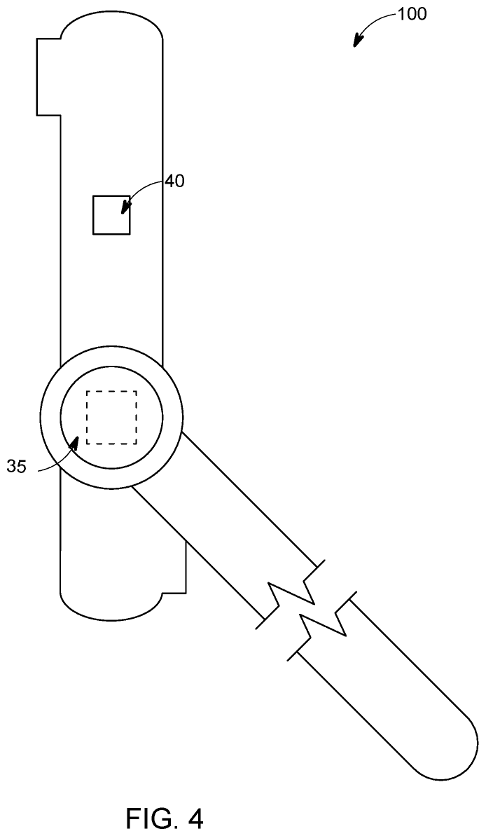

FIG. 4 is a front view of a ratchet attached to the present subject matter without a wrench locked into the present subject matter and represents how a ratchet, breaker bar, or any other tool with a square head can be coupled to the tool for mechanical advantage. In this illustration, the ⅜ inch cutout 40 is not in use.

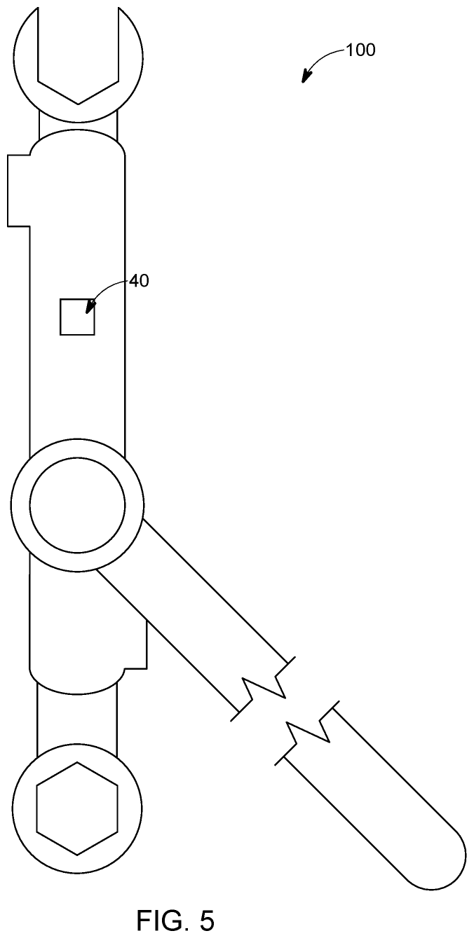

FIG. 5 is a front view of a ratchet attached to the present subject matter with a wrench locked into the present subject matter and represents how a ratchet, breaker bar, or any other tool with a square head can be coupled to the tool for mechanical advantage. In this illustration, the ⅜ inch cutout 40 is not in use.

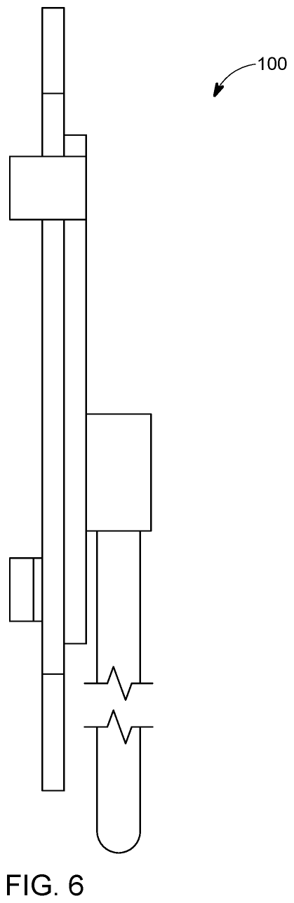

FIG. 6 is a left side view of a ratchet attached to the present subject matter with a wrench locked into the present subject matter and represents how a ratchet, breaker bar, or any other tool with a square head can be coupled to the tool for mechanical advantage.

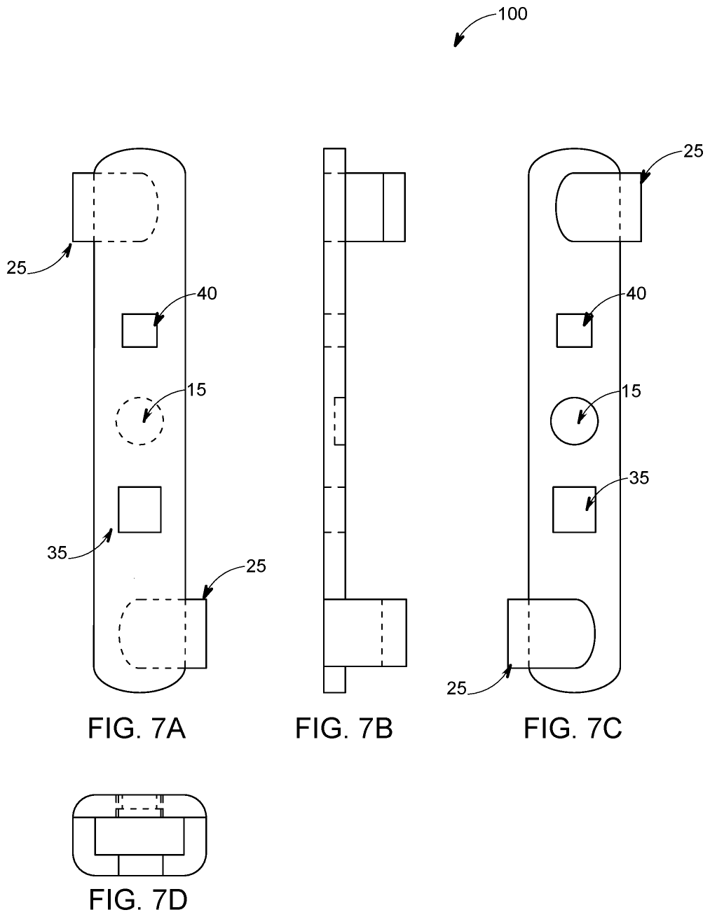

FIG. 7A is a front view of the present subject matter without any wrench or sockets attached to tool for mechanical advantage.

FIG. 7B is a right side view of the present subject matter without any wrench or sockets attached to tool for mechanical advantage.

FIG. 7C is a back side view of the present subject matter without any wrench or sockets attached to tool for mechanical advantage.

FIG. 7D is an end view of the present subject matter without any wrench or sockets attached to tool for mechanical advantage.

What is claimed is:

1. A tool for mechanical advantage comprising of a body 20, two arms 25, two square cutouts 35, 40, a neodymium magnet 15, and a hinge 30.

2. The tool for mechanical advantage comprising of a body 20, two arms 25, two square cutouts 35, 40, a neodymium magnet 15, and a hinge 30 as in claim 1, wherein the two arms 25 latch onto a wrench and work in tandem with neodymium magnet to secure a wrench onto the tool for mechanical advantage.

3. The tool for mechanical advantage comprising of a body 20, two arms 25, two square cutouts 35, 40, a neodymium magnet 15, and a hinge 30 as in claim 1, wherein the tool for mechanical advantage affixes to the wrench and a ratchet, breaker bar, or any other type of tool that uses a square head.

4. The tool for mechanical advantage comprising of a body 20, two arms 25, two square cutouts 35, 40, a neodymium magnet 15, and a hinge 30 as in claim 1, wherein the two square cutouts 35, 40 are 0.5-inch and ⅜-inch and facilitate the attachment of ratchets, breaker bars, or anything with a square head to the tool for mechanical advantage.

5. The tool for mechanical advantage comprising of a body 20, two arms 25, two square cutouts 35, 40, a neodymium magnet 15, and a hinge 30 as in claim 1, wherein in one embodiment hinge 30 allows the user to access fasteners from different angles of approach.

6. A method of constructing a tool for mechanical advantage comprising of a body 20, two arms 25, two square cutouts 35, 40, a neodymium magnet 15, and a hinge 30.

7. The method of constructing the tool for mechanical advantage comprising of the body 20, two arms 25, two square cutouts 35, 40, a neodymium magnet 15, and a hinge 30 as in claim 6, wherein the two arms 25 latch onto a wrench and work in tandem with neodymium magnet to secure a wrench onto the tool for mechanical advantage.

8. The method of constructing the tool for mechanical advantage comprising of the body 20, two arms 25, two square cutouts 35, 40, a neodymium magnet 15, and a hinge 30 as in claim 6, wherein the tool for mechanical advantage affixes to the wrench and a ratchet, breaker bar, or any other type of tool that uses a square head.

9. The method of constructing the tool for mechanical advantage comprising of the body 20, two arms 25, two square cutouts 35, 40, a neodymium magnet 15, and a hinge 30 as in claim 6, wherein the two square cutouts 35, 40 are 0.5-inch and ⅜-inch and facilitate the attachment of ratchets, breaker bars, or anything with a square head to the tool for mechanical advantage.

10. The method of constructing the tool for mechanical advantage comprising of the body 20, two arms 25, two square cutouts 35, 40, a neodymium magnet 15, and a hinge 30 as in claim 6, wherein in one embodiment hinge 30 allows the user to access fasteners from different angles of approach.

11. A method of using a tool for mechanical advantage comprising of a body 20, two arms 25, two square cutouts 35, 40, a neodymium magnet 15, and a hinge 30.

12. The method of using the tool for mechanical advantage comprising of a body 20, two arms 25, two square cutouts 35, 40, a neodymium magnet 15, and a hinge 30 as in claim 11, wherein the two arms 25 latch onto a wrench and work in tandem with neodymium magnet to secure a wrench onto the tool for mechanical advantage.

13. The method of using the tool for mechanical advantage comprising of a body 20, two arms 25, two square cutouts 35, 40, a neodymium magnet 15, and a hinge 30 as in claim 11, wherein the tool for mechanical advantage affixes to the wrench and a ratchet, breaker bar, or any other type of tool that uses a square head.

14. The method of using the tool for mechanical advantage comprising of a body 20, two arms 25, two square cutouts 35, 40, a neodymium magnet 15, and a hinge 30 as in claim 11, wherein the two square cutouts 35, 40 are 0.5-inch and ⅜-inch and facilitate the attachment of ratchets, breaker bars, or anything with a square head to the tool for mechanical advantage.

15. The method of using the tool for mechanical advantage comprising of a body 20, two arms 25, two square cutouts 35, 40, a neodymium magnet 15, and a hinge 30 as in claim 11, wherein in one embodiment hinge 30 allows the user to access fasteners from different angles of approach.
